(19) United States
(12) Patent Application Publication
(10) Pub. No.: US 2006/0064435 A1
(43) Pub. Date: Mar. 23, 2006

(54) Systems and methods for utilizing digital assets

(75) Inventors: James Hodge Firstbrook, Brackendale (CA); Joe Gnocato, Coquitlam (CA); David Kauffman, Vancouver (CA); Rob Morgan, Burnaby (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Creo Inc., Burnaby (CA)

(21) Appl. No.: 11/108,704

(22) Filed: Apr. 19, 2005

Related U.S. Application Data
(60) Provisional application No. 60/611,305, filed on Sep. 21, 2004.

(51) Int. Cl. G06F 17/00

(52) U.S. Cl. 707/104.1

(57) ABSTRACT

Systems and methods for automatically associating managed digital images with information produced by a print production system are described. Locating an image for reuse is simplified by searching associations. Utilizing digital image associations during a print production process ensures that print jobs are processed reliably, efficiently and accurately.

### REFERENCE TO RELATED APPLICATION

The benefit of U.S. application No. 60/611,305 filed on 21 Sep. 2004 is claimed herein.

### TECHNICAL FIELD

This invention pertains to producing printed matter. More specifically the invention relates to processing digital assets during print production to improve creative and print production processes.

### BACKGROUND

Digital asset management systems are known in the prior art. They provide facilities for storing digital assets such as digital images or other creative works that might be reused. Stored assets produced for one set of printed matter can be reused for printed matter produced later. Locating an asset for reuse is typically aided by associating information with it (e.g. the publication name and edition, the publication date, or the creative artist). Prior art provides manual methods for associating information with assets. Manually associated information is problematic because creating it is time consuming and error prone.

Print production systems are known in the prior art. They provide the means for producing printed matter or the precursors of printed matter along with information about the printing process. Linking print production systems with digital asset management systems is known in the prior art where a print production system obtains a referenced asset (e.g. a digital image) from the digital asset management system.

Prior art also shows print production jobs utilizing assets that are stored somewhere other than in a linked digital asset management system. Specifically, assets can be included in creative works submitted for printing or can be stored in an accessible file system. A printer may want to register digital images obtained in this manner with a digital asset management system so that they may be more easily reused. Prior art teaches manual registration of these images.

In other prior art scenarios, a digital image may be stored in a digital asset management system but submitted creative works reference a duplicate digital image stored outside the digital asset management system. It would be advantageous to recognize the duplication and utilize the digital image stored in the digital asset management system.

Developers of creative works can produce works for multiple customers. Prior art print production systems can inadvertently use digital assets belonging to one customer in the work belonging to another customer unless these systems include information and methods for checking this.

Additionally, the creative process is often iterative with multiple revisions of an asset being produced. Prior art systems can inadvertently use the wrong revision of an asset unless the systems include information and methods for tracking and checking revisions. Thus, there are number of aspects of prior art systems and methods that can be improved upon.

### SUMMARY OF THE INVENTION

This invention provides systems and methods for improving the utilization of digital assets (e.g. digital images) in creative and print production processes. This is mainly accomplished by automatically creating associations between printing information, generated as a result of a print production process, and digital assets utilized during the process. In subsequent processes, a digital asset may be more easily located for reuse by exploiting these associations. Advantageous improvements to print production processes are also achieved by a better integration between print production and asset management systems.

Preferred embodiments are based on a client/server software architecture with components, located on different computer systems, communicating using a network. A system according to one embodiment of the invention includes:

At least one print production software module operative to:

create printing information as a result of a print production process wherein creating printing information includes creating an association between a printing entity and a digital asset entity;

add the printing information to a plurality of printing information; and

communicate with a digital asset software module to store or obtain a digital asset entity;

At least one printing information store operative to store a plurality of printing information;

At least one digital asset software module operative to:

locate a digital asset entity by searching a printing information store for a printing entity associated with the digital asset entity wherein the searching is based on a search criteria;

provide a software module with a digital asset entity in response to a communication to obtain a digital asset entity; and

store digital asset associations corresponding to relationships between digital asset entities;

At least one digital asset store operative to store a plurality of digital asset entities; and

At least one client software module operative to:

provide a user with the ability to store a digital asset;

provide a user with the ability to obtain a digital asset based on a search criteria; and

communicate with a digital asset software module to store and obtain digital asset entities.

### BRIEF DESCRIPTION OF DRAWINGS

In drawings which illustrate non-limiting embodiments of the invention:

FIG. 1 is a block diagram illustrating the functional components of one embodiment of the invention.

FIG. 2 is a diagram illustrating a context diagram for refiner software according to one embodiment of the invention.

FIG. 3 is a flow chart diagram illustrating a method for processing images utilized by a creative input according to one embodiment of the invention.

FIG. 4 is a block diagram illustrating the functional components of a refiner according to one embodiment of the invention.

FIG. 5 is a diagram illustrating a high-level information model according to one embodiment of the invention.

FIG. 6 is a diagram illustrating an exemplary information model according to one embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

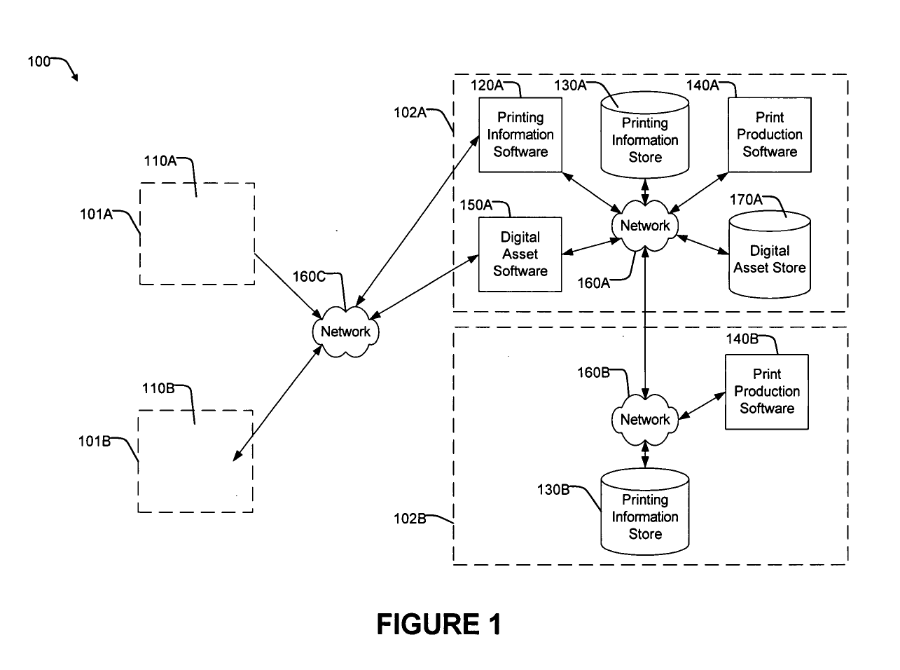

FIG. 1 is a block diagram illustrating the components of a printing system according to one embodiment of the invention. This diagram depicts multiple client software 110 modules located at multiple client locations 101. Client software 110 can be used by an employee, agent, or customer of a printing company that operates a printing system. As an example, client software 110 enables a customer and their agents to collaboratively develop and submit digital creative assets to be printed and then participate in the print production process.

Creating associations between digital assets, such as images, and information generated as part of a print production process is one novel aspect of this invention. The associations simplify the reuse of digital assets in subsequent creative developments.

At a client location 101, client software 110 can be executed on a computer system. In a preferred embodiment, client software 110 executes within a web browser environment. Other environments, including native operating system application program environments, are possible. Client software 110 is capable of communicating with printing information software 120 and digital asset software 150, each located at a server location 102, via network 160C. In some embodiments, client location 101 and server location 102 are the same.

Printing information software 120 provides client software 110 with an environment to initiate and participate in the production phase of printing. Client software 110 uploads creative works to be printed by print production software 140, obtains information about the status of the printing process and enables review of and feedback on results of the printing process. Information provided to client software 110 is obtained from at least one printing information store 130. Printing information software 120 can be configured to communicate with multiple printing information stores 130 to enable information to be segmented. For example, print job information may comprise one segment as it is primarily related to print production software. Information about customers and their users may comprise another segment as it is primarily related to user activity and access restrictions.

Digital asset software 150 provides client software 110 with an environment to manage digital assets during the creative phase of printing. Digital assets such as documents, illustrations and images are stored in digital asset store 170. Assets can be organized into libraries of finished works suitable for reuse. Digital asset store 170 can also include other information, including information about entities related to digital assets and information describing these and other relationships. Digital asset software 150 provides client software 110 with facilities to locate digital assets, download them for use or modification, upload them for safekeeping and sharing, and manage their organization. Digital asset software 150 can be configured to communicate with multiple digital asset stores 170 to enable information to be segmented.

Print production software 140 is responsible for printing jobs. It stores printing information in printing information store 130. The nature and extent of printing information depends on the embodiment of print production software 140. Printing information may include information describing printing entities and their relationships, information about how to process a print job, information about processing steps that have occurred, and other information. Print production software 140 is also responsible for creating associations, determined during print job processing, amongst printing entities and digital assets. In a preferred embodiment, print production software 140 includes prepress software, whose scope is to produce printing precursors (e.g. exposed plates) for printing. In other embodiments, print production software 140 can include other software with different scope (e.g. printing press or finishing).

In preferred embodiments, software modules can be configured to share information stores. This reduces information duplication and improves consistency. For example, access restriction information (e.g. which information is accessible by users) can be shared. As another example, digital asset software 150 can access printing information to facilitate searching for digital assets based on their prior use by print production software 140.

In preferred embodiments, software modules can be configured to communicate with each other to facilitate their tasks. As an example, printing information software 120 communicates with print production software 140 to update printing information with review comments or approval. As another example, print production software 140 communicates with digital asset software 150 to request storage of a digital image detected in creative works submitted for printing.

A server location 102 can comprise one or more computer systems with software and storage modules allocated amongst the computer systems. For example, a single computer system can host all modules. Alternatively, each module can be distributed amongst more than one computer system to balance the processing load. When modules are distributed amongst computer systems, networks 160 facilitate communication between the modules. Distribution amongst multiple server locations 102 is also possible. As an example, printing information software 120A and digital asset software 150A reside at location 102A and are in communication with printing information stores 130A-B via networks 160A-B. Similarly, digital asset store 170A resides at location 102A and is in communication with print production software 140A-B. Similarly, client software 110 can also be hosted by a computer system at server location 102.

Network 160 can comprise equipment and communication links of a variety of types. Examples include wired or wireless types; and personal, local area or wide area types. A variety of communication protocols can also be utilized.

In one preferred embodiment of the invention, Prinergy® workflow software available from Creo Inc. of Burnaby, Canada constitutes print production software 140 and components of printing information store 130. In the same embodiment, Synapse Insite software also available from Creo Inc. of Burnaby, Canada constitutes components of client software 110, printing information software 120 and components of printing information store 130. In the same embodiment, digital asset management software from Creo Inc. constitutes components of client software 110, digital asset software 150 and digital asset store 170.

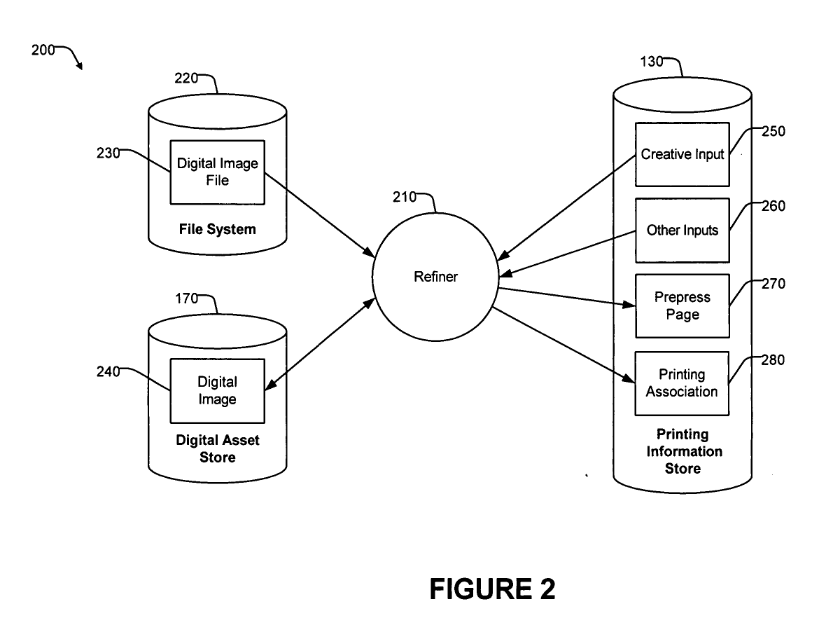

FIG. 2 is a diagram illustrating the operational context for a prepress component of print production software 140 according to one embodiment of the invention. Refiner 210 transforms one or more creative inputs 250, associated with a print job, into one or more prepress pages 270. Refiner 210 enables a printer to establish criteria that enhance the quality, efficiency and reliability of the printed result. A creative input 250 that cannot be transformed to meet the criteria may need to be revised and resubmitted. As an example, criteria may limit the resolution of images and the colors specified for printing. Thus, refining is often the first step in the print production process.

Creative input 250 provides information about one or more pages to be assembled for printing. Creative input 250 can take many forms. For example, creative input 250 can be an electronic file comprising a print description created by executing a print operation in a desktop publishing application. Files of this type may be formatted according to the Adobe® Postscript® or PDF specifications. Other file formats can also be supplied. Creative input 250 supplied as a stream or via other input methods is also within the scope of the invention.

Creative input 250 may reference other inputs 260 that are supplied as part of a print job or are accessible to the print production software 140. For example, fonts may be supplied for a print job or may be accessible to all jobs from printing information store 130. As another example, illustrations and images may also be supplied for a print job as separate files (e.g. encapsulated Postscript™). Similarly, digital image files 230, previously stored in a file system 220 accessible to print production software 140, may be referenced by creative input 250. Similarly, digital images 240, previously stored in digital asset store 170, may be referenced by creative input 250. References to digital images can be made in conformance with Open Prepress Interface (OPI) specifications published by Adobe®.

Refiner 210 can include multiple processing aspects. For example, one aspect can involve conversion to a normalized format (e.g. PDF). Another exemplary aspect can involve transforming colors to match a target profile. Another exemplary aspect can involve OPI processing, where image proxy information is replaced with a referenced high-resolution image.

In a preferred embodiment, each creative input 250 is refined to produce multiple prepress pages 270 corresponding to each page defined by creative input 250. Each prepress page 270 includes information about the page and is associated with at least one file containing the corresponding transformed page description. A page description file encapsulates information from referenced inputs. A prepress page 270 thus represents a digital master of one page derived from creative input 250.

Since refiner 210 performs its tasks in the context of a print job, prepress pages 270 are each associated with a print job entity as a printing association 280 in printing information store 130. Refiner 210 also creates a printing association 280 between prepress page 270 and each digital image 240 encapsulated in its associated page description. Other printing associations 280, corresponding to other aspects of refiner 210 or other components of print production software 140, are possible. Printing associations 280 are more fully described below.

In preferred embodiments, refiner 210 can be one part of a fully configured print production software 140. Alternatively, refiner 210 can be configured as the only part of print production software 140. In this case, interim or final results of creative developments can be verified as being ready to print. Print job information can then be exported into a fully configured print production software 140 to complete print production.

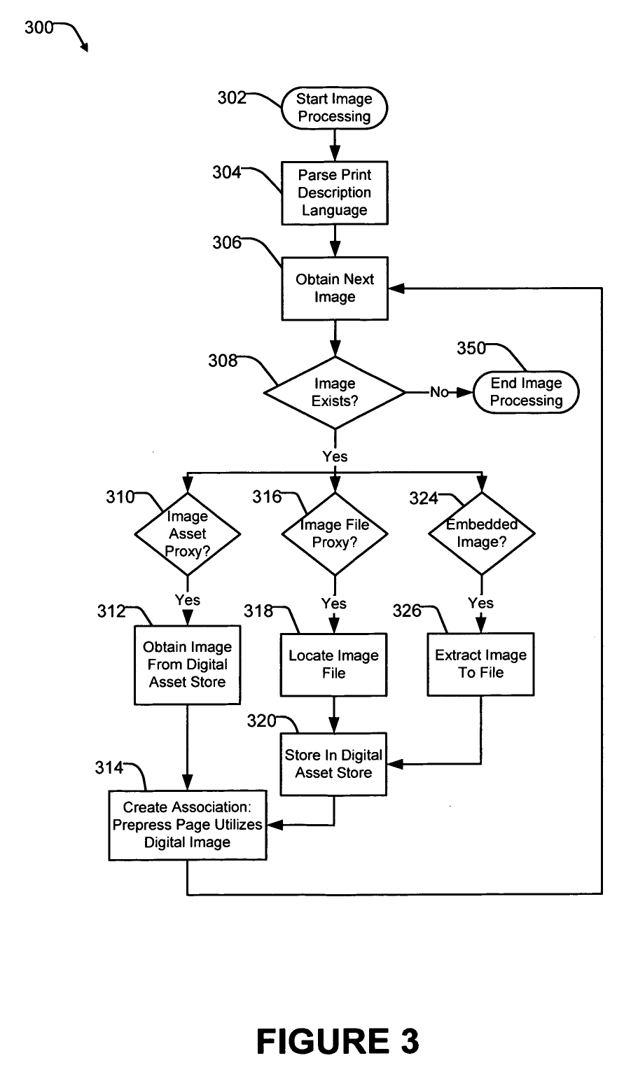

FIG. 3 is a flow chart diagram illustrating a method, performed by refiner 210, for processing images utilized by a creative input 250 according to one embodiment of the invention. The method identifies utilized images and creates an association for each prepress page 270 utilizing a digital image 240. For clarity, other refining aspects, such as creating the prepress page 270, are not shown.

The method starts at block 302 and proceeds to block 304 where refiner 210 parses the print description language syntax to identify images. The method proceeds to block 306 where it attempts to obtain the first image. Next, it proceeds to block 308 where the method determines if an image exists. If not, the method proceeds to block 350 where the method ends. Otherwise, the method determines how to proceed based on which of blocks 310, 316 or 324 yield a positive result.

Block 310 determines whether the image is defined by an OPI image proxy that references a digital image 240 in digital asset store 170. This is done by checking the image description language for an attribute corresponding to an image identifier. The method then proceeds to block 312 where refiner 210 queries digital asset store 170 for information about digital image 240 corresponding to the image identifier. If digital image 240 cannot be located, the method determines whether refining can continue. Rules can be configured to determine the outcome. For example, refiner 210 can treat the situation by continuing with a warning message generated or terminating with an error message generated. This can increase the reliability of the results produced by print production software 140.

In some embodiments, the image identifier includes a revision attribute to identify iterations of an original image having the same main identifier. Digital asset store 170 may contain multiple revisions of a digital image each identified by a different revision attribute. Refiner 210 can also be configured to check the revision referenced by the image proxy with revisions of digital image 240 available in digital asset store 170. Rules can be configured to determine the outcome. For example, warning or error treatment can be defined for different comparison outcomes (e.g. warn and utilize newer stored version if it exists). This can increase the quality of the results produced by print production software 140.

In some embodiments, access to digital images 240 can be restricted. For example, digital asset store 170 can include information describing which printing entities are allowed to access a digital image. Information that can support this is more fully described below. Refiner 210, at block 312 for example, can determine whether the current print job is authorized to access digital image 240 referenced by creative input 250. Rules can be configured to determine treatment similar to that described above. This can increase the reliability of the results produced by print production software 140. Assuming block 312 obtains digital image 240, the method proceeds to block 314.

Proceeding at block 314, the method creates a printing association 280 between digital image 240 and the prepress page 270 utilizing it. This is more fully described below. Next, the method proceeds to block 306 to attempt to obtain the next image.

Block 316 determines whether the image is defined by an OPI image proxy that references a digital image file 230 stored in a file system 220. This is done by checking the image description language for an attribute corresponding to a file name. Refiner 210 searches a configured list of locations in one or more accessible file systems 220 as is common in traditional OPI processing. Once digital image file 230 is located, the method proceeds to block 320 as described below.

Block 324 determines whether the image description language contains the high-resolution pixels. If so, the method proceeds to block 326 where the high-resolution image is copied to a file. Next, the method proceeds to block 320 as described below.

Proceeding at block 320, refiner 210 communicates with digital asset software 150 to store the high-resolution pixels and information about the image as a new digital image 240. In some embodiments, digital asset software 150 can search digital asset store 170 to ensure that the new image is not already stored there. It can use attributes of the new image to perform a comparison. For example, attributes such as resolution, origin (e.g. author, creation date), pixel values, dimension or image digest can be used to locate a matching image. This can increase the efficiency of print production software 140 by ensuring only one copy of the image exists (in digital asset store 170). Next, the method proceeds to block 314 with a digital image identifier corresponding to the newly or already stored digital image 240.

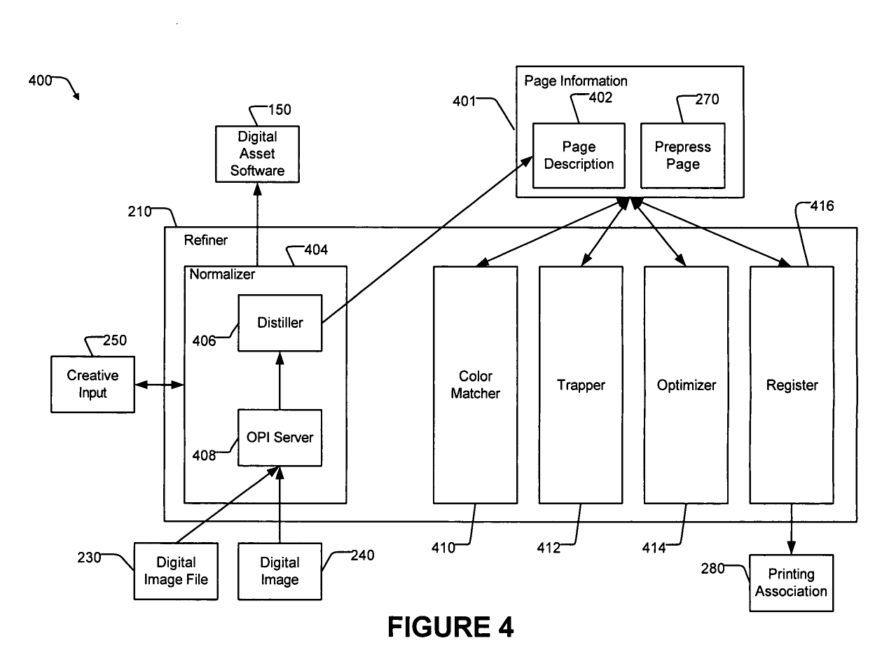

FIG. 4 is a block diagram illustrating the functional components of refiner 210 according to one embodiment of the invention. Describing the interaction of these functional components provides a more detailed understanding of one approach for creating printing association 280. Refiner 210 includes a configurable pipeline of processors. Each processor operates in turn and provides a different aspect of refining. For clarity, only a selected number of potential processors are shown.

Normalizer 404 starts by obtaining creative input 250. If necessary, normalizer 404 converts creative input 250 to postscript format. Normalizer 404 includes an OPI server 408 function that then examines the creative input 250 to identify OPI comments. For each OPI comment, the image identifier or file name included in the comment is used to obtain the high-resolution image from digital image 240 or digital image file 230 respectively. OPI server 408 adds the high-resolution image and additional postscript language to creative input 250. The additional postscript language, when distilled, will create a PDF dictionary entry containing the name of the image identifier or the file pathname.

Normalizer 404 then examines modified creative input 250 to determine if any embedded images exist and stores them as a digital image file 230. Normalizer 404 then requests digital asset software 150 to store each utilized digital image file 230. Digital asset software 150 responds, providing an image identifier for each corresponding digital image 240. Normalizer 404 then updates creative input 250 to ensure that, for each high-resolution image, additional postscript language exists that will create a PDF dictionary entry containing the name of the corresponding image identifier.

Next, distiller 406 interprets modified creative input 250 and transforms it into an equivalent PDF format. Normalizer 404 splits the resultant PDF into page descriptions 402 with each corresponding to one page of creative input 250.

Next, each processor in the pipeline performs its task. Each can access and modify page descriptions 402. Finally, register 416 records page descriptions 402 as prepress pages 270 in the database. Register 416 also interprets each page description 402 to identify the PDF dictionary entries containing utilized image identifiers. For each dictionary entry, register 416 stores the prepress page 270 identifier corresponding to page description 402 and the digital image 240 identifier as an instance of a printing association 280. The foregoing description describes one approach for creating printing association 280 from a creative input 250. Other equivalent approaches are also possible that achieve the same results.

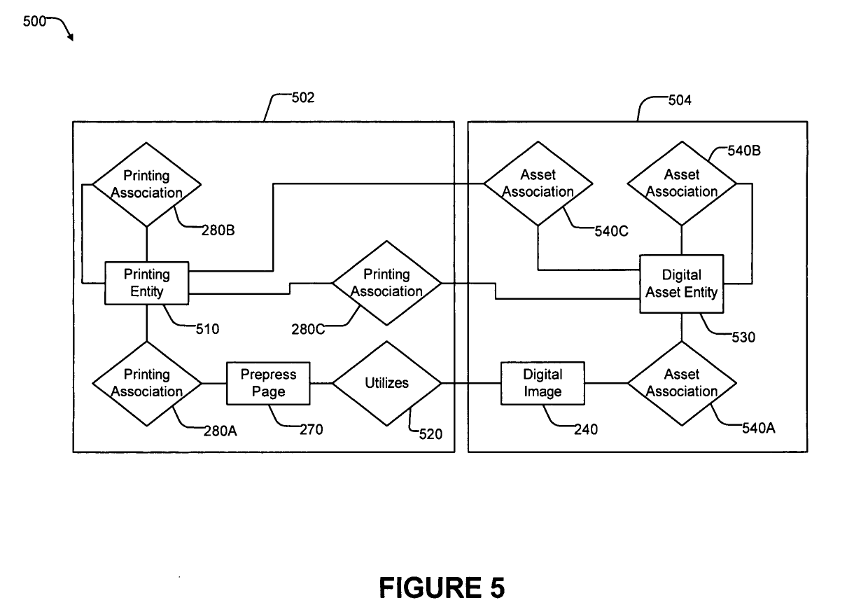

FIG. 5 is a diagram illustrating a high-level information model according to one embodiment of the invention. Printing information 502, created by print production software 140, is depicted as containing several types of entities (depicted symbolically by rectangles) and associations (depicted symbolically by diamonds). Digital asset information 504, created by digital asset software 150, is depicted similarly. Association types are connected to one or more entity types by lines. This indicates that the connected entity types are related by a specific type of association. Both entities and associations can include attributes to hold information about instances of an entity or association. In a preferred embodiment, printing information 502 and digital asset information 504 are stored in a database to simplify searching.

Most printing information 502 is created during the course of a print production process. For example, entities and associations are created during the process of printing a job to determine how prepress pages will be arranged on printed media. Most digital asset information 504 is created during the course of a creative process. For example, digital assets created as part of a creative project can be related.

Printing entity 510 represents any of a number of types of printing entities. Prepress page 270 depicts a specific type of printing entity 510. Printing association 280 represents any of a number of types of printing associations. UTILIZES 520 depicts a specific type of printing association 280. UTILIZES 520 indicates that a prepress page 270 utilizes a digital image 240. For clarity, association cardinalities are not shown. The non-specific entity and association types indicate that printing information 502 can contain many types of printing associations 280 between many types of printing entities 510. More examples of these are described below.

Similarly, digital asset entity 530 represents any number of types of digital assets. Digital image 240 depicts a specific type of digital asset 530. Asset association 540 represents any of a number of types of asset associations.

FIG. 5 also indicates that associations can span information stores as depicted by UTILIZES 520, printing association 280C and asset association 540C. To maintain referential integrity between the information stores, entities of a specific type are given unique identifiers and software that creates an association must obtain and include the related identifiers in the association. Thus, for example, digital asset software 150 can reliably locate and retrieve a digital image 240 if the software has a prepress page 270 identifier, whose page description previously included digital image 240, by examining UTILIZES 520 association. This would typically be done on behalf of client software 110 during a creative process.

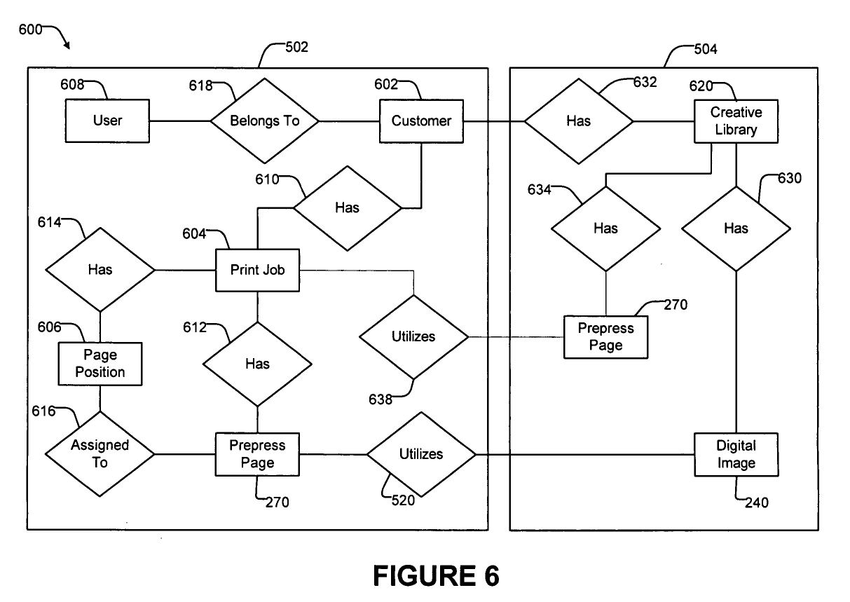

FIG. 6 is a diagram illustrating an exemplary information model according to some embodiments of the invention. For simplicity, only selected entities and associations are depicted.

Customer 602 represents an organization that provides printing work to a printer. User 608 represents an individual that belongs to 618 customer 602. Print production software 140 can use this information for operational and security purposes. Printing work done on behalf of a customer 602 is recorded as a print job 604 via the HAS 610 association. A print job 604 is associated with many entities. Print job 604 HAS 614 one or more page positions 606. Each page position 606 represents a reader-ordered page to be printed. Similarly, print job 604 HAS 612 a collection of prepress pages 270 that have been refined. A printing employee creates multiple ASSIGNED TO 616 associations between a page position 606 and a prepress page 270 when she determines the reader order of refined pages.

Customer 602, BELONGS TO 618 and user 608 are shared by digital asset software 150 for organizational and security purposes. A customer 602 HAS 632 a creative library 620 which is a repository for a collection of digital images 240. The collection is represented by the HAS 630 association.

This simplified information model can be used to explain a few of the novel aspects of the invention. Locating a digital image 240 can be based on establishing a search criteria. For example, a user operating client software 110 may wish to locate a digital image 240 that was printed on a particular page of a particular edition of a publication. Digital asset software 150 searches printing information 502 and digital asset information 504 using an expression comprising a set of entities, associations and assertions on their attribute values. SQL is an example of a language suitable for expressing search criteria.

Publication name and edition can be attributes of print job 604. The search identifies a print job 604 based on the publication and edition attributes. HAS 614 can include a page number attribute that is used to locate the particular page position 606 corresponding to the particular page printed by the print job 604. Next, the search identifies a prepress page 270 associated with the page position 606 via ASSIGNED TO 616. Finally, the search identifies one or more digital images 240 by examining UTILIZES 520. Digital asset software 150 retrieves preview images for the digital images 240 and presents them to client software 110 for user selection of the specific digital image 240 of interest. Thus, an indirect association between a print job 604 and a digital image 240 is used to locate the image.

A simple access restriction method can be supported by the depicted information model. For example, digital asset software 150 can require client software 110 to supply a user 608 identifier when locating images. Digital asset software 150 can ensure that only a user 608 that BELONGS TO 618 a customer 602 that HAS 632 a creative library 620 may access a digital image 240 that is part of (i.e. equivalent to HAS 630) creative library 620. Similarly, print production software 140, processing print job 604 that HAS 612 a prepress page 270, that attempts to UTILIZE 520 a digital image 240 will generate an error unless print job 604 and creative library 620, containing the digital image 240, are both directly associated with customer 602 (e.g. via HAS 610 and HAS 632 respectively). Of course, other associations can be created to allow more sophisticated access restrictions.

In other preferred embodiments, additional printing associations 280 can be created between digital asset entities 530 (not limited to digital images) and printing entities 510. For example, one or more prepress pages 270, imported into a print job 604 from an asset store 170 as a digital asset, can be directly associated with print job 604 or other printing entities 510 associated with print job 604.

This type of association can be made, for example, when printing packages. Package printing can involve creating a refined prepress page 270 for each distinct printed package layout. In the packaging industry, a single package layout is usually referred to as an artwork file or a 1-up but these are conceptually similar to a prepress page in that each comprises a unit of creative content. For clarity, a package artwork file or 1-up is hereafter referred to as a prepress page. Each prepress page 270 can be produced, for example, as part of an initial print job 604 whose purpose is not to produce output but to produce a print-ready prepress page 270 for later use. Such a prepress page 270 is stored, either manually or automatically, in a digital asset store 170 for subsequent use. Printing associations 280 created as part of an initial print job 604 can be used to locate a prepress page 270 for use in a subsequent print job 604. FIG. 6 depicts prepress page 270, as part of digital asset information 504, and utilizes 520, as part of printing information 503, as additional exemplary entities and associations.

In a subsequent print job 604, one or more prepress pages 270 can be arranged for printing on a single media. Prepress pages 270 can be located as part of creating an arrangement specification (e.g. creating an imposition plan) for use in subsequent print job 604. Alternatively, prepress pages can be located as part of a process of directly importing them into subsequent print job 604. Additional printing associations 280 can be created between subsequent print job 604 and prepress page 270 (already stored in asset store 170). For example, associations between prepress page 270 and subsequent print job 604 or an entity corresponding to the arrangement specification can be made. Locating can be simplified by searching printing associations 280 created as part of earlier print jobs 604.

It can be readily appreciated that other associations can advantageously be created between these and additional entity types that are maintained by print production software 140 and digital asset software 150. For example, a printing press software module can provide information about press, paper and ink entity types. Instances of these can be associated with a sheet or plate entity provided by a prepress software module. These associations can provide additional avenues for locating digital assets.

Certain implementations of the invention comprise computer processors, which execute software instructions, which cause the processors to perform a method of the invention. For example, client software 110, printing information software 120, print production software 140 and digital asset software 150 can all be implemented by providing software, which runs on, or more computer systems and causes the computer systems to operate according to the methods described above. The program product may comprise any medium which carries a set of computer-readable signals comprising instructions which, when executed by a computer processor, cause the computer processor to execute a method of the invention. The program product may be in any of a wide variety of forms. The program product may comprise, for example, physical media such as magnetic storage media including floppy diskettes, hard disk drives, optical data storage media including CD ROMs, DVDs, electronic data storage media including ROMs, flash RAM, or the like or transmission-type media such as digital or analog communication links. The instructions may optionally be compressed and/or encrypted on the medium.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method for locating a digital asset, the method comprising:
in a print production process creating printing information, the printing information comprising an association between a printing entity and a digital asset entity utilized in the print production process;
adding the printing information to a collection of printing information; and
subsequently locating the digital asset entity by examining the collection of printing information according to a search criteria.

2. A method according to claim 1 wherein the search criteria includes information identifying the printing entity associated with the digital asset.

3. A method according to claim 1 wherein the collection of printing information is stored in a printing information store; the digital asset entity is stored in a digital asset store; and the stores are included in at least one searchable database.

4. A method according to claim 3 wherein the
printing information store stores a plurality of printing entities of a plurality of printing entity types, and a plurality of printing associations of a plurality of printing association types;
digital asset store comprises a plurality of digital asset entities of a plurality of digital asset entity types, and a plurality of asset associations of a plurality of asset association types; and,
printing entities and the digital asset entities each comprise an identifier.

5. A method according to claim 4 wherein:
the printing entity comprises a prepress page and the digital asset entity comprises a digital image; and
the method comprises:
processing a creative input to create the prepress page;
identifying a digital image utilized at least in part by the prepress page; wherein adding the printing information to the collection of printing information comprises
creating and storing an association between the prepress page and the digital image.

6. A method according to claim 5 wherein creating the association between the prepress page and the digital image comprises creating an indirect association wherein at least one other entity is directly associated with both the prepress page and the digital image.

7. A method according to claim 3 wherein
the association between a printing entity and a digital asset entity comprises an association between a print job and a prepress page respectively; and
the method comprises:
identifying a prepress page, stored in a digital asset store, included in an arrangement of pages to be output for a print job; and,
creating the association between the print job and the prepress page.

8. A method according to claim 7 wherein creating the association between the print job and the prepress page comprises creating an indirect association by associating at least one other entity with each of the print job and the prepress page.

9. A method according to claim 5 wherein the search criteria comprises at least one attribute value assertion and examining the collection of information comprises comparing the attribute value assertion to attribute values of entities and associations in the at least one searchable database.

10. A method according to claim 9 comprising locating a digital asset by, at least in part, identifying a printing entity that is directly associated with the digital asset.

11. A method according to claim 5 wherein identifying a digital image utilized at least in part by the prepress page comprises identifying the digital image by obtaining a digital image identifier from an image proxy associated with a page defined by the creative input.

12. A method according to claim 5 wherein identifying a digital image utilized at least in part by the prepress page comprises:
locating the digital image, referenced by a page defined by the creative input, outside a digital asset store;
storing the digital image as a stored digital image in a digital asset store; and
obtaining a digital image identifier corresponding to the stored digital image.

13. A method according to claim 12 wherein locating the digital image outside a digital asset store comprises locating the digital image embedded in the creative input.

14. A method according to claim 12 wherein locating the digital image outside a digital asset store comprises locating the digital image in a file, the file having a name that is included in an image proxy associated with the creative input.

15. A method according to claim 4 wherein
the plurality of asset associations includes a plurality of asset access associations, each asset access association identifying an entity's right to access the corresponding digital asset; and
the print production process comprises an attempt to access a digital asset wherein the attempt is successful based on an asset access association between the digital asset and an entity associated with the print production process.

16. A method according to claim 11 wherein a digital image identifier comprises a main identifier and a revision identifier.

17. A method according to claim 16 wherein processing a creative input to create a prepress page proceeds based on a comparison of revision identifiers corresponding to an image proxy and a digital image, stored in a digital asset store, having the same main identifier.

18. A method according to claim 12 wherein storing the digital image in the digital asset store comprises:
first determining whether a stored digital image is substantially the same as the digital image; and
if the stored digital image is not substantially the same as the digital image, storing the digital image.

19. A method according to claim 17 wherein obtaining a digital image identifier corresponding to the digital image in the digital asset store comprises obtaining the digital image identifier corresponding to the stored digital image if the stored digital image is substantially the same as the digital image.

20. A method for automatically creating associations between printing information and a digital asset, the method comprising:
creating printing information as a result of a print production process wherein creating printing information includes creating an association between a printing entity and a digital asset entity utilized in the print production process; and
adding the printing information to a plurality of printing information.

21. A method for automatically storing a digital asset in a digital asset store, comprising:
performing a print production process;
identifying a digital asset utilized by the print production process wherein the digital asset is located outside the digital asset store; and
storing the digital asset in the digital asset store.

22. A method according to claim 21 wherein the digital asset is a digital image identified by processing a creative input and locating the digital image in the creative input or in a storage facility different than the digital asset store.

23. A method according to claim 21 wherein the digital asset is a prepress page identified by processing a creative input to create the prepress page and the prepress page is manually or automatically selected for reuse.

24. A system for locating a digital asset, the system comprising:
means for creating printing information as a result of a print production process wherein creating printing information includes creating an association between a printing entity and a digital asset entity utilized in the print production process;
means for adding the printing information to a plurality of printing information;
means for subsequently locating the digital asset entity by examining the plurality of printing information for digital asset entities associated with the printing entity, the examining based on a search criteria.

25. An apparatus for locating a digital asset to be reused, the apparatus comprising at least one print production software module operative to:
create printing information as a result of a print production process wherein creating printing information includes creating an association between a printing entity and a digital asset entity;
add the printing information to a plurality of printing information; and
communicate with a digital asset software module to store or obtain a digital asset entity;
at least one printing information store operative to store a plurality of printing information;
at least one digital asset software module operative to:
locate a digital asset entity by searching a printing information store for a printing entity associated with the digital asset entity wherein the searching is based on a search criteria;
provide a software module with a digital asset entity in response to a communication to obtain a digital asset entity; and
store digital asset associations corresponding to relationships between digital asset entities;
at least one digital asset store operative to store a plurality of digital asset entities; and
at least one client software module operative to:
provide a user with the ability to store a digital asset;
provide a user with the ability to obtain a digital asset based on a search criteria; and
communicate with a digital asset software module to store and obtain digital asset entities.

26. A medium carrying a set of computer-readable signals comprising instructions which, when executed by a data processor, cause the data processor to execute a method according to claim 1.
